(19) United States
(12) Patent Application Publication
(10) Pub. No.: US 2026/0010253 A1
(43) Pub. Date: Jan. 8, 2026

(54) FOLDABLE ELECTRONIC DEVICE

(71) Applicant: SAMSUNG ELECTRONICS CO., LTD., Suwon-si (KR)

(72) Inventors: Gyuyeong CHO, Suwon-si (KR); Sangil PARK, Suwon-si (KR); Jaedeok LIM, Suwon-si (KR)

(73) Assignee: SAMSUNG ELECTRONICS CO., LTD., Suwon-si (KR)

(21) Appl. No.: 19/323,682

(22) Filed: Sep. 9, 2025

Related U.S. Application Data
(63) Continuation of application No. PCT/KR2024/002964, filed on Mar. 7, 2024.

(30) Foreign Application Priority Data
Mar. 11, 2023 (KR) 10-2023-0032161
Mar. 22, 2023 (KR) 10-2023-0037221

(51) Int. Cl. G06F 3/041; G06F 3/044; G06F 3/046

(52) U.S. Cl. CPC G06F 3/04162; G06F 3/04182; G06F 3/0418; G06F 3/0442; G06F 3/0443; G06F 3/046; G06F 2203/04102; G06F 2203/04107

(57) ABSTRACT

A foldable electronic device includes: a first housing; a second housing; a hinge structure rotatably connecting the first housing and the second housing; a flexible display on the first housing and the second housing; a folding area accommodated on the flexible display; a shielding space facing the folding area and being between the hinge structure and the flexible display; a pair of digitizers being spaced apart below the flexible display; a pair of first shielding members below each of the pair of digitizers and being spaced apart from each other by the shielding space therebetween; and a plurality of second shielding members in the shielding space, wherein a first resistance of the plurality of second shielding members is higher than a second resistance of the pair of first shielding members.

### CROSS-REFERENCE TO RELATED APPLICATIONS

This application is a by-pass continuation application of International Application No. PCT/KR2024/002964, filed on Mar. 7, 2024, which is based on and claims priority to Korean Patent Application No. 10-2023-0032161, filed on Mar. 11, 2023, and Korean Patent Application No. 10-2023-0037221, filed on Mar. 22, 2023, in the Korean Intellectual Property Office, the disclosures of which are incorporated by reference herein their entireties.

### BACKGROUND

### 1. Field

Embodiments of the disclosure relate to a foldable electronic device including

a shielding member for preventing malfunction of a pen input device due to magnetic field interference.

### 2. Description of Related Art

An electronic device may support a pen input device (e.g., a stylus pen). A user may, e.g., input data to an electronic device using a pen input device and perform various tasks (e.g., writing or drawing) on a screen output to a display of the electronic device.

An electronic device may, e.g., receive various input data, text, or drawing signals from an electromagnetic resonance (EMR) type pen input device. For example, a display of an electronic device may include a digitizer for detecting a signal from a pen input device.

An EMR type pen input device includes an LC resonance circuit composed of a coil and a capacitor. A pen input device transmits a signal of a resonance frequency by an LC resonance circuit to a digitizer of an electronic device, and the electronic device detects the signal of the resonance frequency transmitted through the digitizer and performs an operation (e.g., writing or drawing) corresponding to an input of a pen.

A resonance frequency of a signal transmitted from a pen input device may vary according to changes in an inductance of a coil and a capacitance of a capacitor.

For example, when a pen tip of a pen input device is pressed against a display of an electronic device, a capacitance of a capacitor in the pen input device may increase, and a digitizer recognizes a pen input signal by detecting a change in a resonance frequency according to the increase in capacitance.

Similar to the change in capacitance, when an inductance of a coil in a pen input device changes, a resonance frequency of a signal from the pen input device may also vary. For example, when an inductance of a coil in a pen input device decreases due to magnetic field interference caused by a magnetic field generated from a component having magnetic force in an electronic device, a resonance frequency also decreases. In this case, even when there is an actual pen input and there is an increase in a capacitance of a capacitor, a decrease in an inductance of a coil may offset this, so that a digitizer may not recognize a pen input and may malfunction.

### SUMMARY

An electronic device (e.g., a foldable electronic device) may be provided to perform a folding or unfolding operation of a housing around a hinge.

For example, a foldable electronic device may perform folding/unfolding operations in an in-folding and/or out-folding manner by rotatably connecting a first housing and a second housing constituting a housing through a hinge. In this case, when a first housing and a second housing of a foldable electronic device are folded or unfolded through a hinge, a display disposed on an upper portion of the housing is also folded or unfolded together.

In a foldable electronic device, a hinge supporting folding/unfolding operation functions of the foldable electronic device has characteristics of not only a soft magnetic material with high magnetic permeability but also a hard magnetic material having magnetic force like a magnet. Due to these characteristics, a hinge may be magnetized by an external magnetic force to generate a magnetic field, and a magnetic field due to hinge magnetization may cause fluctuation and malfunction of a coil inductance of a pen input device.

One or more embodiments of the disclosure may provide a foldable electronic device with little inductance fluctuation of a pen input device even when magnetization of a hinge occurs.

One or more embodiments of the disclosure may provide a foldable electronic device configured to reduce an influence of magnetization of such a hinge on a coil inductance of a pen input device even when a hinge is composed of a thin, high-strength material for slimming of an electronic device.

According to an aspect of the disclosure, a foldable electronic device includes: a first housing; a second housing; a hinge structure rotatably connecting the first housing and the second housing; a flexible display on the first housing and the second housing; a folding area accommodated on the flexible display; a shielding space facing the folding area and being between the hinge structure and the flexible display; a pair of digitizers being spaced apart below the flexible display; a pair of first shielding members below each of the pair of digitizers and being spaced apart from each other by the shielding space therebetween; and a plurality of second shielding members in the shielding space, wherein a first resistance of the plurality of second shielding members is higher than a second resistance of the pair of first shielding members.

Effects of the present disclosure are not limited to the foregoing, and other unmentioned effects would be apparent to one of ordinary skill in the art from the following description. In other words, unintended effects in practicing embodiments of the disclosure may also be derived by one of ordinary skill in the art from example embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

In connection with the description of the drawings, the same or similar reference numerals may be used to denote the same or similar elements.

FIG. 1 is a block diagram illustrating an electronic device in a network environment according to one or more embodiments;

FIG. 2A is a view illustrating an unfolded state of an electronic device according to an embodiment of the disclosure;

FIG. 2B is a view illustrating a folded state of an electronic device according to an embodiment of the disclosure;

FIG. 3 is an exploded perspective view illustrating an electronic device according to an embodiment of the disclosure;

FIG. 4 is a view illustrating an operating principle of a pen input device according to an embodiment of the disclosure;

FIG. 5A is a cross-sectional view illustrating an electronic device cut along line I-I′ illustrated in FIG. 2A according to an embodiment of the disclosure;

FIG. 5B is a cross-sectional view illustrating an electronic device cut along line I-I′ illustrated in FIG. 2A according to an embodiment of the disclosure;

FIG. 6 is a cross-sectional view illustrating an electronic device cut along line I-I′ illustrated in FIG. 2A according to an embodiment of the disclosure;

FIG. 7A is a cross-sectional view illustrating an electronic device cut along line I-I′ illustrated in FIG. 2A according to an embodiment of the disclosure;

FIG. 7B is a cross-sectional view illustrating an electronic device cut along line I-I′ illustrated in FIG. 2A according to an embodiment of the disclosure;

FIG. 8 is a view illustrating a method of scanning an inductance of a pen input device moving on a display of an electronic device according to an embodiment of the disclosure and an inductance of the scanned pen input device; and

FIGS. 9 to 11 are views for comparing shielding performance according to a stacked structure of a display of an electronic device according to an embodiment of the disclosure.

### DETAILED DESCRIPTION

One or more embodiments of the present disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

A singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

If an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., through a wire or wires), wirelessly, or via a third element.

The terms “comprise” and/or “have,” as used herein, specify the presence of stated features, integers, steps, operations, elements, and/or components, but do not preclude the presence or addition of one or more other features, integers, steps, operations, elements, components, and/or groups thereof.

When a component is referred to as “connected to,” “coupled to”, “supported on,” or “contacting” another component, the components may be connected to, coupled to, supported on, or contact each other directly or via a third component.

Throughout the disclosure, when one component is positioned “on” another component, the first component may be positioned directly on the second component, or other component(s) may be positioned between the first and second component.

The term “and/or” may denote a combination(s) of a plurality of related components as listed or any of the components.

Hereinafter, embodiments of the present disclosure are described with reference to the accompanying drawings.

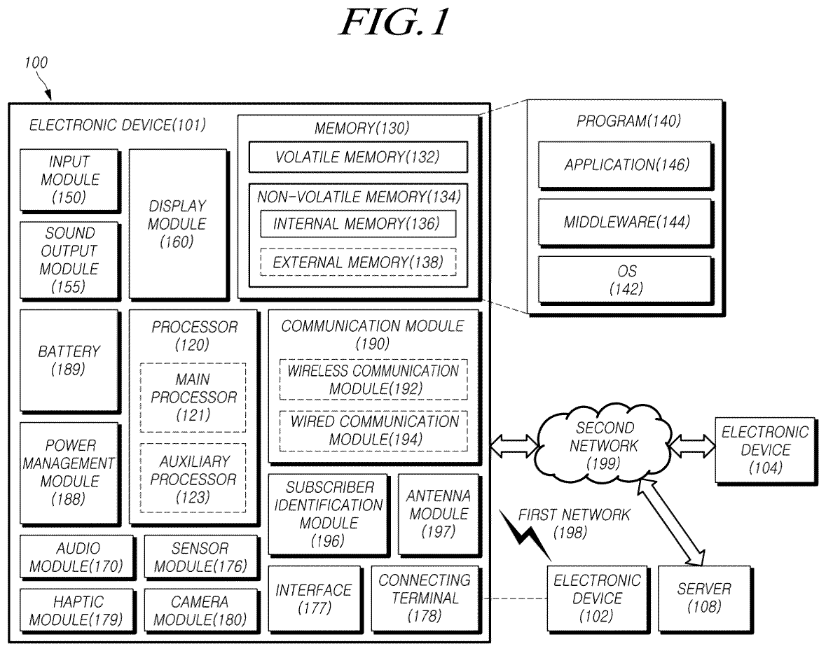

FIG. 1 is a block diagram illustrating an electronic device 101 in a network environment 100 according to various embodiments;

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the sub processor 123, the sub processor 123 may be configured to use lower power than the main processor 121 or to be specified for a designated function. The sub processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display 160 may include, for example, a display, a hologram device, or a projector and control circuitry to control a corresponding one of the display, hologram device, and projector. According to an embodiment, the display 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an accelerometer, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

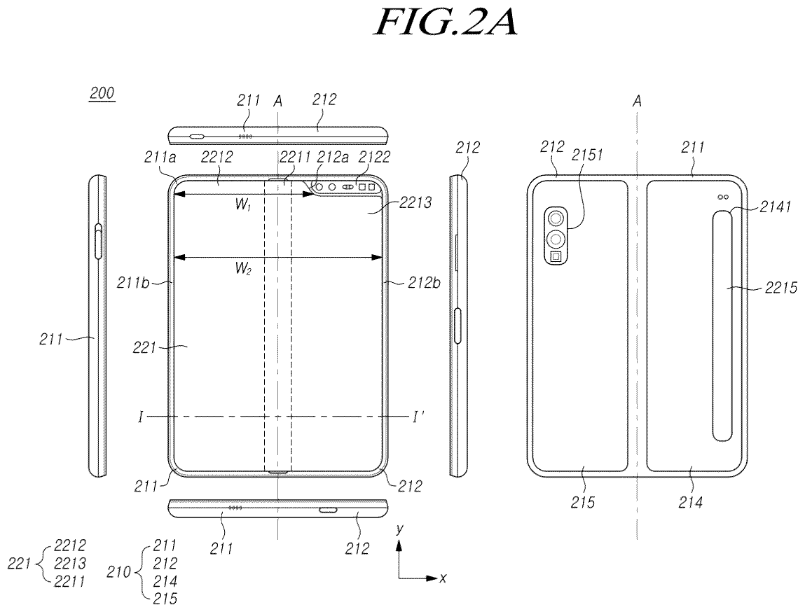

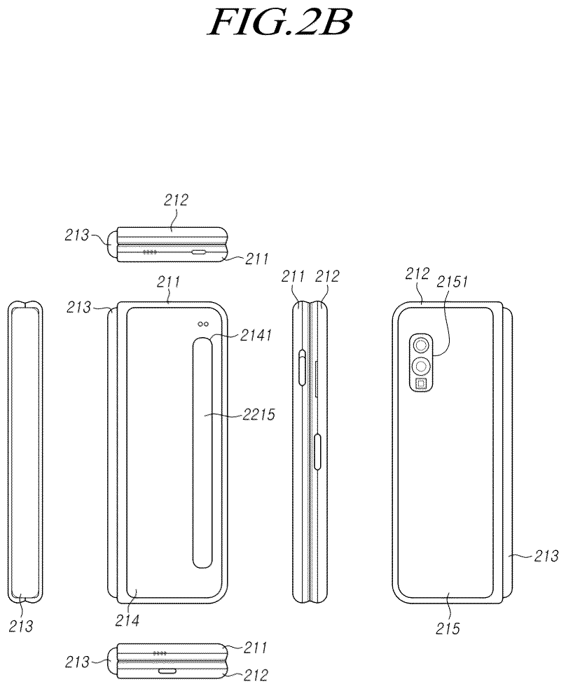

FIG. 2A is a view illustrating an unfolded state of an electronic device according to an embodiment of the disclosure. FIG. 2B is a view illustrating a folded state of an electronic device according to an embodiment of the disclosure.

Referring to FIGS. 2A and 2B, in an embodiment, an electronic device 200 (e.g., the electronic device 101 of FIG. 1) may include a foldable housing 210, a hinge cover 213 covering a foldable portion of the foldable housing 210, and a flexible or foldable display 221 disposed in a space formed by the foldable housing 210. In the disclosure, a surface where the display 221 is disposed is defined as a first surface or a front surface of the electronic device 200. The opposite surface of the front surface is defined as a second surface or a rear surface of the electronic device 200. The surface surrounding the space between the front and rear surfaces is defined as a third surface or a side surface of the electronic device 200.

According to an embodiment, the foldable housing 210 may include a first housing structure 211 (or a first housing 211), a second housing structure 212 (or a second housing 212) including a sensor area 2122, a first rear cover 214, and a second rear cover 215. The foldable housing 210 of the electronic device 200 are not limited to the shape and coupling shown in FIGS. 2A and 2B but may rather be implemented in other shapes or via a combination and/or coupling of other components. For example, in another embodiment, the first housing structure 211 and the first rear cover 214 may be integrally formed with each other, and the second housing structure 212 and the second rear cover 215 may be integrally formed with each other.

In an embodiment, the first housing structure 211 and the second housing structure 212 may be positioned on opposite sides of a folding axis (axis A), and they may be overall symmetrical in shape with each other with respect to the folding axis A. As set forth below, the first housing structure 211 and the second housing structure 212 may have different angles or distances formed therebetween depending on whether the electronic device 200 is in an unfolded, folded, or intermediate state. In an embodiment, the second housing structure 212, unlike the first housing structure 211, may additionally include the sensor area 2122 where various sensors are arranged, but may otherwise have a mutually symmetrical shape. In another embodiment, the sensor area 2122 may additionally be disposed in, or replaced by, at least a partial area of the first housing structure 211 or the second housing structure 212.

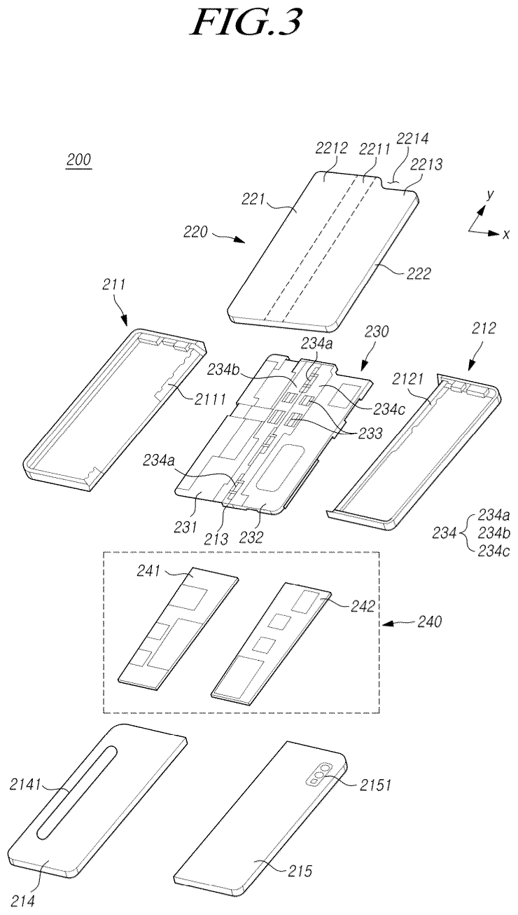

In an embodiment, the electronic device 200 may operate in an in-folding manner and/or an out-folding manner by rotating the first housing structure 211 with respect to the second housing structure 212 in a range of 0 degrees to 360 degrees through a hinge structure (the hinge structure 234 of FIG. 3). According to one or more embodiments, the hinge structure 234 may be formed in a vertical direction or a horizontal direction when the electronic device 200 is viewed from above. According to one or more embodiments, there may be provided a plurality of hinge structures 234. For example, the plurality of hinge structures may all be arranged in the same direction. As another example, some hinge structures among the plurality of hinge structures may be arranged and folded in different directions.

According to an embodiment, as shown in FIG. 2A, the first housing structure 211 and the second housing structure 212 together may form a recess to receive the display 221. In an embodiment, due to the sensor area 2122, the recess may have two or more different widths in the direction perpendicular to the folding axis A.

For example, the recess may have (a) a first width W1 between a first portion 211a parallel to the folding axis A of the first housing structure 211 and a first portion 212a formed at an edge of the sensor area 2122 of the second housing structure 212 and (b) a second width W2 formed by a second portion 211b of the first housing structure 211 and a second portion 212b parallel to the folding axis A and not corresponding to the sensor area 2122 of the second housing structure 212. In this case, the second width W2 may be longer than the first width W1. In other words, the first portion 211a of the first housing structure 211 and the first portion 212a of the second housing structure 212, asymmetric in shape with each other, may form the first width W1 of the recess, and the second portion 212b of the first housing structure 211 and the second portion 212b of the second housing structure 212, symmetric in shape with each other, may form the second width W2 of the recess. In an embodiment, the first portion 212a and second portion 212b of the second housing structure 212 may differ in distance from the folding axis A. The width of the recess is not limited thereto. According to one or more embodiments, the recess may have a plurality of widths due to the shape of the sensor area 2122 or the asymmetric portions of the first housing structure 211 and the second housing structure 212.

In an embodiment, the first housing structure 211 and the second housing structure 212 may at least partially be formed of a metal or non-metallic material with a rigidity selected to support the display 221.

In an embodiment, the sensor area 2122 may be formed adjacent to a corner of the second housing structure 212 and to have a predetermined area. However, the placement, shape, or size of the sensor area 2122 is not limited to those illustrated. For example, in another embodiment, the sensor area 2122 may be provided in a different corner of the second housing structure 212 or in any area between the top corner and the bottom corner. In an embodiment, components for performing various functions, embedded in the electronic device 200, may be exposed through the sensor area 2122 or one or more openings in the sensor area 2122 to the front surface of the electronic device 200. In one or more embodiments, the components may include various kinds of sensors. The sensors may include at least one of, e.g., a front camera, a receiver, a proximity sensor, an illuminance sensor, an iris recognition sensor, an ultrasonic sensor, and an indicator.

In an embodiment, the first rear cover 214 may be disposed on one side of the folding axis on the rear surface of the electronic device and have a substantially rectangular periphery which may be surrounded by the first housing structure 211. Similarly, the second rear cover 215 may be disposed on the opposite side of the folding axis on the rear surface of the electronic device and its periphery may be surrounded by the second housing structure 212.

In an embodiment, the first rear cover 214 and the second rear cover 215 may be substantially symmetrical in shape with respect to the folding axis (axis A). However, the first rear cover 214 and the second rear cover 215 are not necessarily symmetrical in shape. In another embodiment, the electronic device 200 may include the first rear cover 214 and the second rear cover 215 in various shapes. In another embodiment, the first rear cover 214 may be integrally formed with the first housing structure 211, and the second rear cover 215 may be integrally formed with the second housing structure 212.

In an embodiment, a combined structure of the first rear cover 214, the second rear cover 215, the first housing structure 211, and the second housing structure 212 may form a space where various components (e.g., a printed circuit board or battery) of the electronic device 200 may be disposed. According to an embodiment, one or more components may be arranged or visually exposed on/through the rear surface of the electronic device 200. For example, at least a portion of a sub display 2215 may be visually exposed through a first rear surface area 2141 of the first rear cover 214. In another embodiment, one or more components or sensors may be visually exposed through a second rear surface area 2151 of the second rear cover 215. According to one or more embodiments, the sensor may include a proximity sensor and/or a rear-facing camera.

Referring to FIG. 2B, the hinge cover 213 may be disposed between the first housing structure 211 and the second housing structure 212 to hide the internal components (e.g., the hinge structure). According to an embodiment, the hinge cover 213 may be hidden by a portion of the first housing structure 211 and second housing structure 212 or be exposed to the outside depending on the state (e.g., the unfolded state or folded state) of the electronic device 200.

For example, as shown in FIG. 2A, in the unfolded state of the electronic device 200, the hinge cover 213 may be hidden, and thus not exposed, by the first housing structure 211 and the second housing structure 212. By way of example, as shown in FIG. 2B, in the folded state (e.g., the fully folded state) of the electronic device 200, the hinge cover 213 may be exposed to the outside between the first housing structure 211 and the second housing structure 212. As an example, in an intermediate state in which the first housing structure 211 and the second housing structure 212 are folded with a certain angle, the hinge cover 213 may be partially exposed to the outside between the first housing structure 211 and the second housing structure 212. However, in this case, the exposed area may be smaller than that in the completely folded state. In an embodiment, the hinge cover 213 may include a curved surface.

The display 221 may be disposed on a space formed by the foldable housing 210. For example, the display 221 may be seated on a recess formed by the foldable housing 210 and may occupy most of the front surface of the electronic device 200.

Thus, the front surface of the electronic device 200 may include the display 221 and a partial area of the first housing structure 211 and a partial area of the second housing structure 212, which are adjacent to the display 221. The rear surface of the electronic device 200 may include the first rear cover 214, a partial area of the first housing structure 211, which is adjacent to the first rear cover 214, the second rear cover 215, and a partial area of the second housing structure 212, which is adjacent to the second rear cover 215.

The display 221 may mean a display at least a portion of which may be transformed to be flat or curved. According to an embodiment, the display 221 may include a folding area 2211, a first area 2212 disposed on one side of the folding area 2211 (e.g., the left side of the folding area 2211 of FIG. 2A), and a second area 2213 disposed on the opposite side of the folding area 2211 (e.g., the right side of the folding area 2211 of FIG. 2A).

The segmentation of the display 221 as shown in FIG. 2A is merely an example, and the display 221 may be divided into a plurality of (e.g., four or more, or two) areas depending on the structure or function of the display 221. For example, in the embodiment illustrated in FIG. 2A, the display 221 may be divided into the areas by the folding area 2211 or folding axis (axis A) extending in parallel with the y axis, or the display 221 may be divided into the areas with respect to another folding area (e.g., a folding area parallel with the x axis) or another folding axis (e.g., a folding axis parallel with the x axis).

The first area 2212 and the second area 2213 may be overall symmetrical in shape with respect to the folding area 2211. However, unlike the first area 2212, the second area 2213 may include a notch (2214 of FIG. 3) depending on the presence of the sensor area 2122, but the rest may be symmetrical in shape with the first area 2212. In other words, the first area 2212 and the second area 2213 may include symmetrical portions and asymmetrical portions.

Described below are the operation of the first housing structure 211 and the second housing structure 212 and each area of the display 221 depending on the state (e.g., the unfolded state (flat state) and folded state) of the electronic device 200.

According to an embodiment, when the electronic device 200 is in the unfolded state (flat state) (e.g., FIG. 2A), the first housing structure 211 and the second housing structure 212 may be angled at 180 degrees therebetween, facing in the same direction. The surface of the first area 2212 and the surface of the second area 2213 of the display 221 may be angled at 180 degrees therebetween while facing in the same direction (e.g., forward of the front surface of the electronic device). The folding area 2211 may be coplanar with the first area 2212 and the second area 2213.

According to an embodiment, when the electronic device 200 is in the folded state (e.g., FIG. 2B), the first housing structure 211 and the second housing structure 212 may be disposed to face each other. The surface of the first area 2212 and the surface of the second area 2213 of the display 221 may be angled at a small angle (e.g., ranging from 0 degrees to 10 degrees) therebetween while facing each other. At least a portion of the folding area 2211 may be formed as a curve having a predetermined curvature.

According to an embodiment, when the electronic device 200 is in the intermediate state, the first housing structure 211 and the second housing structure 212 may be disposed at a certain angle therebetween. The surface of the first area 2212 of the display 221 and the surface of the second area 2213 may form an angle which is larger than the angle in the folded state and smaller than the angle in the unfolded state. The folding area 2211 may at least partially have a curved surface with a predetermined curvature and, in this case, the curvature may be smaller than that when it is in the folded state.

FIG. 3 is an exploded perspective view illustrating an electronic device according to an embodiment of the disclosure.

Referring to FIG. 3, according to an embodiment, an electronic device 200 may include a display unit 220, a bracket assembly 230, a circuit board unit 240, a first housing structure 211, a second housing structure 212, a first rear cover 214, and a second rear cover 215. In the disclosure, the display unit 220 may be referred to as a display module or display assembly.

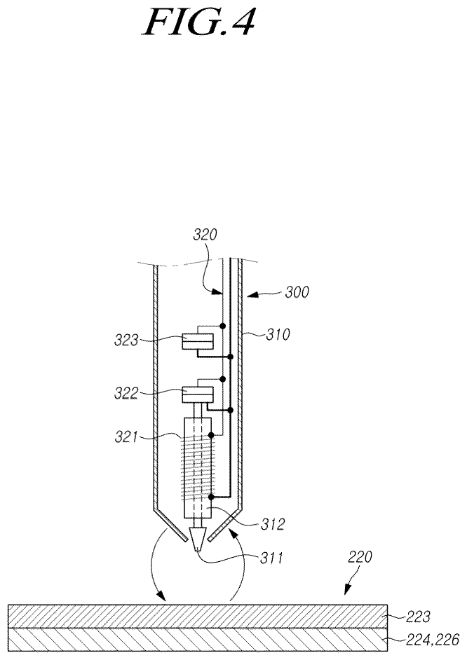

The display unit 220 may include a display 221 and one or more plates or layers 222 on which the display 221 is seated. In an embodiment, one or more plates or layers 222 may include various configurations including a digitizer (e.g., the digitizer 223 of FIG. 3) for detecting an input signal input from a pen input device (e.g., the pen input device 300 of FIG. 4), which is described below, and one or more shielding members (e.g., the shielding members 224 and 226 of FIG. 3) for shielding magnetic field induction between the pen input device 300 and components of the electronic device 200. According to an embodiment, the plate 222 may be disposed between the display 221 and the bracket assembly 230. The display 221 may be disposed on at least a portion of one surface (e.g., an upper surface of FIG. 3) of the plate 222. The plate 222 may be formed in a shape corresponding to the display 221. For example, a portion of the plate 222 may be formed in a shape corresponding to the notch 2214 of the display 221.

The bracket assembly 230 may include a first bracket 231, a second bracket 232, a hinge structure 234 disposed between the first bracket 231 and the second bracket 232, a hinge cover 213 covering the hinge structure 234 when the hinge structure 234 is viewed from the outside, and a wiring member 233 (e.g., a flexible printed circuit board (FPCB)) crossing the first bracket 231 and the second bracket 232.

In an embodiment, the bracket assembly 230 may be disposed between the plate 222 and the circuit board unit 240. As an example, the first bracket 231 may be disposed between the first area 2212 of the display 221 and a first circuit board 241. The second bracket 232 may be disposed between the second area 2213 of the display 221 and a second circuit board 242.

According to an embodiment, the wiring member 233 and the hinge structure 234 may be at least partially disposed inside the bracket assembly 230. The wiring member 233 may be disposed in a direction (e.g., the x-axis direction) crossing the first bracket 231 and the second bracket 232. The wiring member 233 may be disposed in a direction (e.g., the x-axis direction) perpendicular to the folding axis (e.g., the folding axis A of FIG. 2A or the y axis) of the folding area 2211.

In an embodiment, the hinge structure 234 may include a hinge module 234a, a first hinge plate 234b and/or a second hinge plate 234c. In an embodiment, the hinge module 234a may be understood as a concept including a first hinge plate 234b and a second hinge plate 234c. In an embodiment, the first hinge plate 234b may be mounted inside the first housing structure 211, and the second hinge plate 234c may be mounted inside the second housing structure 212. In an embodiment, the first hinge plate 234b may be coupled to a first bracket 231, and the second hinge plate 234c may be coupled to a second bracket 232. In an embodiment, the first hinge plate 234b (or the second hinge plate 234c) may be coupled to another structure (e.g., a first rotation support surface 2111 or a second rotation support surface 2121) inside the first housing structure 211 (or the second housing structure 212). For example, a structure to which the first hinge plate 234b (or the second hinge plate 234c) is coupled inside the first housing structure 211 (or the second housing structure 212) may vary according to embodiments. In an embodiment, the hinge module 234a may be coupled to the first hinge plate 234b and the second hinge plate 234c to rotatably connect the second hinge plate 234c to the first hinge plate 234b. For example, a folding axis (e.g., the folding axis A of FIG. 1) is formed by the hinge module 234a, and the first housing structure 211 and the second housing structure 212 (or the first bracket 231 and the second bracket 232) may rotate relative to each other substantially around the folding axis A.

As mentioned above, the circuit board unit 240 may include the first circuit board 241 disposed on the first bracket 231 and the second circuit board 242 disposed on the second bracket 232. The first circuit board 241 and the second circuit board 242 may be disposed inside a space formed by the bracket assembly 230, the first housing structure 211, the second housing structure 212, the first rear cover 214, and the second rear cover 215. Components for implementing various functions of the electronic device 200 may be disposed on the first circuit board 241 and the second circuit board 242.

The first housing structure 211 and the second housing structure 212 may be assembled together to be coupled to both sides of the bracket assembly 230, with the display unit 220 coupled to the bracket assembly 230. As described below, the first housing structure 211 and the second housing structure 212 may slide from both sides of the bracket assembly 230 and fit with the bracket assembly 230.

According to an embodiment, the first housing structure 211 may include a first rotation supporting surface 2111, and the second housing structure 212 may include a second rotation supporting surface 2121 corresponding to the first rotation supporting surface 2111. The first rotation supporting surface 2111 and the second rotation supporting surface 2121 may include a curved surface corresponding to a curved surface included in the hinge cover 213.

According to an embodiment, the first rotation supporting surface 2111 and the second rotation supporting surface 2121, in the unfolded state of the electronic device 200 (e.g., the electronic device of FIG. 2A), may cover the hinge cover 213, allowing the hinge cover 213 to be not or minimally exposed to the rear surface of the electronic device 200. The first rotation supporting surface 2111 and the second rotation supporting surface 2121, in the folded state of the electronic device 200 (e.g., the electronic device of FIG. 2B), may rotate along the curved surface included in the hinge cover 213, allowing the hinge cover 213 to be maximally exposed to the rear surface of the electronic device 200.

FIG. 4 is a view illustrating an operating principle of a pen input device according to an embodiment of the disclosure.

FIG. 4 schematically illustrates a portion of a configuration of a pen input device 300 and a portion of a configuration of an electronic device (e.g., the electronic device 200 of FIG. 3) for detecting a pen input from the pen input device 300. In FIG. 4, illustration of configurations of the remaining electronic device is omitted except for some configurations for describing an operating principle of the pen input device 300.

FIG. 4 schematically illustrates a digitizer 223 and shielding members 224 and 226 corresponding to a portion of a display unit 220 of the electronic device 200 of FIG. 3 and an internal configuration of a portion of the pen input device 300.

In an embodiment, the digitizer 223 may be provided to detect a pen input from the pen input device 300. In an embodiment, the shielding members 224 and 226 may be provided to shield magnetic field induction between the pen input device 300 and internal configurations of the electronic device 200. Detailed descriptions of the components 223, 224, and 226 are described below.

In an embodiment, the pen input device 300 may transmit a pen input signal to the digitizer 223. For example, the pen input device 300 may generate a pen input signal including a predetermined resonance frequency signal using an electromagnetic resonance (EMR) method and transmit the generated pen input signal to the digitizer 223.

In an embodiment, the pen input device 300 may include a pen housing 310 forming an exterior and a resonance circuit 320 for generating a pen input signal.

In an embodiment, the pen housing 310 may have substantially a pen shape, but the disclosure is not limited thereto. For example, an opening that opens downward may be formed at a lower portion of the pen housing 310. At least a portion of a pen tip 311 may be inserted and mounted inside the pen input device 300 through the opening and exposed to the outside.

In an embodiment, the resonance circuit 320 may include a coil 321 wound multiple times around a ferrite 312 provided inside the pen housing 310 and a plurality of capacitors 322 and 323. In an embodiment, the plurality of capacitors 322 and 323 may be electrically connected to the pen tip 311. The plurality of capacitors 322 and 323 may include a variable capacitor 322 and a fixed capacitor 323. The plurality of capacitors 322 and 323 may have a capacitance value that changes according to a pressure change applied to the pen tip 311.

For example, among the plurality of capacitors 322 and 323, the variable capacitor 322 may have a gap between electrodes that changes according to a degree of pressure applied to the pen tip 311, and correspondingly, a capacitance value may change. Therefore, when pressure applied to the pen tip 311 increases, a capacitance value of the resonance circuit 320 may increase. Further, when pressure applied to the pen tip 311 decreases, a capacitance value of the resonance circuit 320 may decrease.

In an embodiment, the coil 321 may form a resonance frequency signal in a preset frequency band (e.g., 500 Khz). The plurality of capacitors 322 and 323 electrically connected to the coil 321 may adjust a resonance frequency of a signal formed by the coil 321. In an embodiment, a resonance frequency generated by the pen input device 300 may be defined as ½π\sqrt{LC}. Here, L means the inductance of the coil 321, and C means the total capacitance of the resonance circuit 320. For example, a total capacitance may be a sum of a capacitance of the variable capacitor 322 and a capacitance of the fixed capacitor 323.

In an embodiment, a resonance frequency of the resonance circuit 320 may change according to an inductance value of the coil 321 and capacitance values of the capacitors 322 and 323. For example, when a capacitance of the resonance circuit 320 increases or decreases as pressure applied to the pen tip 311 increases or decreases, the digitizer 223 may detect a change in a resonance frequency of a signal transmitted from the pen input device 300 and accordingly recognize a pen input of the pen input device 300.

Further, a change in an inductance of the coil 321 may change a resonance frequency in the same way as a change in a total capacitance of the capacitors 322 and 323. For example, when an inductance of the coil 321 increases, this may decrease a resonance frequency as in a case where a total capacitance increases. In this case, even when the pen input device 300 is floating in the air, the digitizer 223 that detects a decrease in a resonance frequency may recognize that a pen input occurs. For example, when an inductance of the coil 321 decreases, this may increase a resonance frequency as in a case where a total capacitance decreases. In this case, even when pressure is applied to the pen tip 311 of the pen input device 300, the digitizer 223 that detects an increase in a resonance frequency may not recognize occurrence of a pen input.

An inductance of the coil 321 may be affected by an external magnetic field. For example, when a metal material is present around the coil 321, an induced current (or eddy current) flows in the metal material due to a magnetic field generated by the coil 321. The induced current may form a magnetic field in a direction that cancels a magnetic field generated by the coil 321. In this case, an inductance of the coil 321 may be decreased as a total magnetic field is decreased by an induced current generated in surrounding metal materials.

For example, when a hard magnetic material having magnetic force like a magnet is present around the coil 321, the hard magnetic material may be magnetized by an external magnetic force to form a magnetic field. In this case, the magnetic field may be induced to a magnetic material (e.g., the ferrite 312 or the shielding members 224 and 226), reducing a magnetic permeability of the magnetic material and reducing an inductance of the coil 321.

According to an embodiment, the shielding members 224 and 226 may shield an external magnetic field that causes a change in an inductance of the coil 321 so that a pen input from the pen input device 300 may be properly detected.

In an embodiment, in a case of the foldable electronic device 200, a hinge structure (e.g., the hinge structure 234 of FIG. 3) may be included as a component (or metal material) that reduces an inductance of the coil 321. In an embodiment, the hinge structure 234 may be formed of stainless steel material overall to secure rigidity and may have characteristics of a hard magnetic material. In an embodiment, the hinge structure 234 may be composed of a combination of a magnetizable material (e.g., stainless steel) and a non-magnetizable material (e.g., cobalt alloy). For example, the hinge structure 234 may be composed only of a stainless steel material.

An electronic device 200 according to an embodiment may include a shielding structure capable of reducing an induced current generated in the electronic device 200 due to a magnetic field generated by the coil 321 of the pen input device 300 and limiting an inductance deviation of the coil 321 within a predetermined range before and after magnetization of the hinge structure 234. Details thereof are described below.

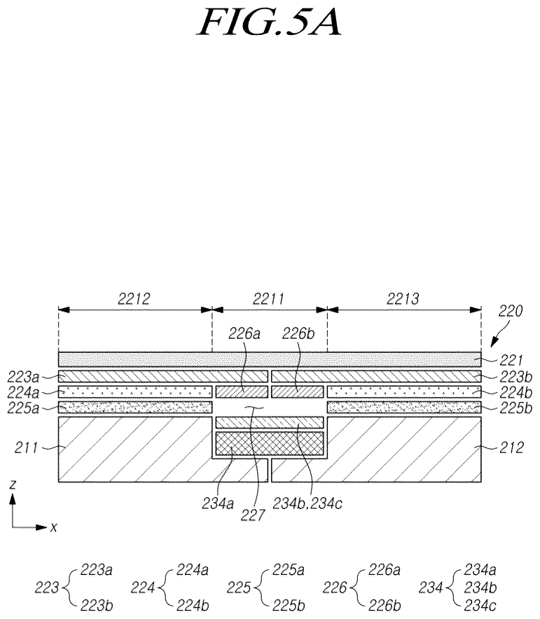

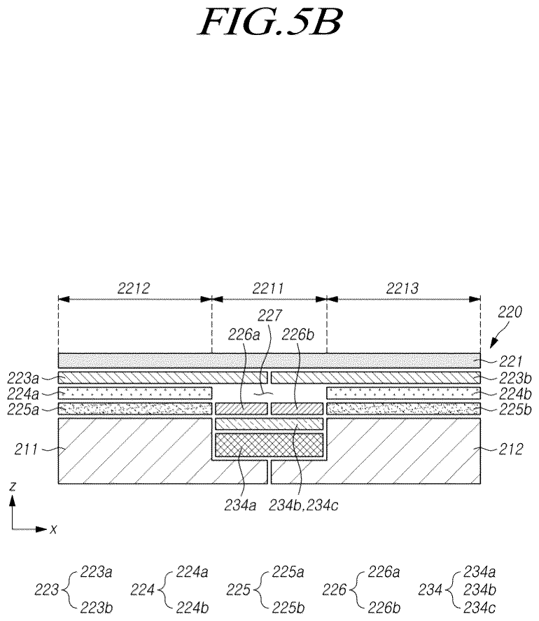

FIG. 5A is a cross-sectional view illustrating an electronic device cut along line I-I′ illustrated in FIG. 2A according to an embodiment of the disclosure. FIG. 5B is a cross-sectional view illustrating an electronic device cut along line I-I′ illustrated in FIG. 2A according to an embodiment of the disclosure.

Specifically, FIG. 5A illustrates an electronic device 200 according to an embodiment in which a second shielding member 226 to be described below is attached to a lower portion of a digitizer 223, and FIG. 5B illustrates an electronic device 200 according to an embodiment in which a second shielding member 226 is attached to an upper portion of a hinge structure 234.

Referring to FIGS. 5A and 5B, an electronic device 200 is a foldable electronic device and may include a folding area 2211 and a first area 2212 and a second area 2213 disposed with the folding area 2211 therebetween.

In an embodiment, a display unit 220 of the electronic device 200 may include a display 221, a digitizer 223, a first shielding member 224, and a conductive member 225 sequentially stacked from an upper side to a lower side.

In an embodiment, the digitizer 223 may be disposed below (or may be below) the display 221. The digitizer 223 may be electrically connected to the display 221 to transmit and/or receive a magnetic field (or signal). The digitizer 223 may recognize a pen input device (e.g., the pen input device 300 of FIG. 4) approaching or contacting the display 221. The digitizer 223 may generate a signal corresponding to X-Y coordinate values corresponding to a point where the pen input device 300 is positioned when the pen input device 300 moves on the display 220.

In an embodiment, the digitizer 223 may have a separated structure. For example, the digitizer 223 may include a first digitizer 223a and a second digitizer 223b disposed to be (or being) spaced apart from each other below the display 221. The first digitizer 223a may be attached to a lower portion of the display 221 facing the folding area 2211 and the first area 2212. The second digitizer 223b may be attached to a lower portion of the display 221 facing the folding area 2211 and the second area 2213.

In an embodiment, the first shielding member 224 may shield an external magnetic field from being induced to a metal material (e.g., the conductive member 225 and/or the first housing structure 211 and the second housing structure 212) in the electronic device 200. For example, the first shielding member 224 may shield a magnetic field generated by the pen input device 300 so that a magnetic field generated by a coil 321 of the pen input device 300 is not induced to a metal material in the electronic device 200. In an embodiment, the first shielding member 224 may shield so that a magnetic field is not induced between a metal material in the electronic device 200 and the pen input device 300.

In an embodiment, the first shielding member 224 may be composed of a magnetic material (e.g., a soft magnetic material) with high magnetic permeability to shield a magnetic field. For example, the first shielding member 224 may be composed of magnetic metal powder such as sendust formed of Fe—Si—Al, but the disclosure is not limited thereto.

In an embodiment, the first shielding member 224 may be disposed below the digitizer 223.

In an embodiment, the first shielding member 224 may have a separated structure. For example, the first shielding member 224 may include a 1-1th (first-first) shielding member 224a and a 1-2th (first-second) shielding member 224b disposed to be spaced apart from each other below the digitizer 223.

In an embodiment, the 1-1th shielding member 224a may be disposed below the first digitizer 223a. For example, the 1-1th shielding member 224a may be disposed in a lower area of the first digitizer 223a corresponding to the first area 2212 of the display 221.

In an embodiment, the 1-2th shielding member 224b may be disposed below the second digitizer 223b. For example, the 1-2th shielding member 224b may be disposed in a lower area of the second digitizer 223b corresponding to the second area 2213 of the display 221.

In other words, the 1-1th shielding member 224a and the 1-2th shielding member 224b may be spaced apart with a lower area of the digitizer 223 corresponding to the folding area 2211 of the display 221 therebetween. In other words, the 1-1th shielding member 224a and the 1-2th shielding member 224b may be understood as a structure in which at least a portion is removed so as not to face the hinge structure 234 in the lower area (e.g., the shielding space 227) of the digitizer 223.

In an embodiment, the conductive member 225 may be composed of a metal material such as copper (Cu), but the disclosure is not limited thereto.

In an embodiment, a portion of a magnetic field (or residual magnetic field) generated by the coil 321 of the pen input device 300 that is not induced to the first shielding member 224 may be induced to the conductive member 225. In this case, an induced current due to a residual magnetic field may flow inside the conductive member 225. The induced current may generate a magnetic field that offsets a magnetic field generated by the coil 321 of the pen input device 300. When an induced current flowing in the conductive member 225 increases, an inductance of the coil 321 of the pen input device 300 may decrease, causing a malfunction in which the electronic device 200 does not properly recognize a pen input. To prevent the malfunction, in an embodiment, the first shielding member 224 may be composed of a material having a relatively low magnetic permeability fluctuation range due to a surrounding magnetic field. Further, as is described below, in an embodiment, the conductive member 225 may have a structure in which at least a portion is removed from the above-described shielding space 227. The conductive member 225 is described below in detail.

In an embodiment, the conductive member 225 may be disposed below the first shielding member 224.

In an embodiment, the conductive member 225 may have a separated structure. For example, the conductive member 225 may include a first conductive member 225a and a second conductive member 225b disposed to be spaced apart from each other below the first shielding member 224.

In an embodiment, the first conductive member 225a may be disposed below the 1-1th shielding member 224a. For example, the first conductive member 225a may be disposed in a lower area of the 1-1th shielding member 224a corresponding to the first area 2212 of the display 221.

In an embodiment, the second conductive member 225b may be disposed below the 1-2th shielding member 224b. For example, the second conductive member 225b may be disposed in a lower area of the 1-2th shielding member 224b corresponding to the second area 2213 of the display 221. In other words, the first conductive member 225a and the second conductive member 225b may be spaced apart with a lower area of the digitizer 223 corresponding to the folding area 2211 of the display 221 therebetween. In other words, the first conductive member 225a and the second conductive member 225b may be understood as a structure in which at least a portion is removed so as not to face the hinge structure 234 in the lower area (e.g., the shielding space 227) of the digitizer 223.

In an embodiment, the display unit 220 may include a second shielding member 226 disposed in a shielding space 227. Here, the shielding space 227 may mean a space surrounded by the digitizer 223, the first shielding member 224, the conductive member 225, and the hinge structure 234. Further, the shielding space 227 may mean an area facing the hinge structure 234.

In an embodiment, the second shielding member 226 may shield an external magnetic field from being induced to a metal material (e.g., the conductive member 225 and/or the hinge structure 234) in the electronic device 200. For example, the second shielding member 226 may shield a magnetic field generated by the pen input device 300 so that a magnetic field generated by a coil 321 of the pen input device 300 is not induced to a metal material in the electronic device 200. For example, the second shielding member 226 may shield the magnetic field so that a magnetic field generated as a component having magnetic force such as a hinge structure 234 disposed in the electronic device 200 is magnetized is not transmitted to the pen input device 300.

In an embodiment, the second shielding member 226 may be composed of a magnetic material (e.g., a soft magnetic material) with high magnetic permeability to shield a magnetic field. For example, the second shielding member 226 may be composed of magnetic metal powder such as XFLUX formed of Fe—Si, but the disclosure is not limited thereto.

In an embodiment, a magnetic permeability of the second shielding member 226 may be decreased by an external magnetic field. A magnetic material has a property that magnetic permeability (or initial magnetic permeability) decreases when a strength of an external magnetic field increases. The second shielding member 226 may be composed of a material having a very low magnetic permeability fluctuation range for external magnetic field changes so as to shield a magnetic field generated due to magnetization of the hinge structure 234 from being transmitted to the pen input device 300.

Regarding the magnetic permeability, a magnetic material has a characteristic called resistance (or magnetic stability) that is inversely proportional to magnetic permeability. Here, resistance may mean a ratio obtained by dividing the magnetic permeability changed in an external magnetic field environment by the initial magnetic permeability (=magnetic permeability during magnetization/initial magnetic permeability).

In an embodiment, the first shielding member 224 and the second shielding member 226 may have physical property values according to [Table 1] below.

TABLE 1

| | Magnetic | Magnetic | | | |
|---|---|---|---|---|---|
| | permeability | permeability | Resis- | Thick- | Perfor- |
| | (initial) | (50G) | tance | ness | mance |
| First | 100 | 30 | 30% | 50 um | 5000 |
| shielding | | | | | |
| member | | | | | |
| Second | 50 | 25 | 50% | 50 um | 2500 |
| shielding | | | | | |
| member | | | | | |

Referring to Table 1, the first shielding member 224 has an initial magnetic permeability of 100, a magnetic permeability of 30 in a 50 Gauss magnetic field environment, a resistance of 30% (=30/100), and a performance of 5000. Here, performance means magnetic field shielding performance and may mean a value obtained by multiplying initial magnetic permeability and thickness. The second shielding member 226 has an initial magnetic permeability of 50, a magnetic permeability of 25 in a 50 Gauss magnetic field environment, a resistance of 50% (=25/50), and a performance of 2500.

In an embodiment, the second shielding member 226 may have higher resistance than the first shielding member 224. In this case, the second shielding member 226 has a relatively low magnetic permeability fluctuation even after magnetization of the hinge structure 234 occurs. Accordingly, magnetic field interference from the hinge structure 234 to an inductance of the pen input device 300 may be decreased.

According to an embodiment, as illustrated in Table 1, the second shielding member 226 may have higher resistance than the first shielding member 224 while having a lower initial magnetic permeability. Due to the low initial magnetic permeability of the second shielding member 226, to prevent an induced current and magnetic field generated in a metal material in the electronic device 200 from affecting the pen input device 300, in an embodiment, at least a portion of the conductive members 225a and 225b corresponding to an upper area of the hinge structure 234 may be removed as described above. In this case, in an upper area (e.g., the shielding space 227) of the hinge structure 234, a problem of magnetic field generation due to an induced current of the conductive members 225a and 225b may be eliminated. Further, magnetic field interference between an inside of the electronic device 200 and the pen input device 300 may be decreased even by the second shielding member 226 having a relatively low initial magnetic permeability. In an embodiment, the hinge structure 234 is composed of a metal material but is composed of an assembly (or module) composed of small-sized components, having a structure in which an induced current is difficult to generate. Therefore, an influence of an induced current generated in the hinge structure 234 may be relatively less important compared to a case of the conductive members 225a and 225b.

As such, as the second shielding member 226 having higher resistance than a shielding member in other spaces (e.g., the first shielding member 224) is disposed in the shielding space 227, magnetic field interference due to magnetization of the hinge structure 234 by an external magnetic field may be decreased. Further, an inductance fluctuation deviation of the coil 321 of the pen input device 300 before and after magnetization of the hinge structure 234 is decreased, and overall operating performance of the pen input device 300 may be enhanced. In other words, magnetic field shielding performance for the pen input device 300 may be enhanced. Therefore, for slimming of the hinge structure 234, even in an environment where magnetization of the hinge structure 234 becomes greater by composing the hinge structure 234 only of a material having higher rigidity than existing materials, such as stainless steel, the electronic device 200 may maintain stable magnetic field shielding performance.

In an embodiment, the second shielding member 226 may have a separated structure.

For example, the second shielding member 226 may include, as illustrated in FIG. 5A, a 2-1th shielding member 226a disposed below the first digitizer 223a and a 2-2th shielding member 226b disposed below the second digitizer 223b. The 2-1th shielding member 226a may be disposed in a lower area of the first digitizer 223a corresponding to the folding area 2211 of the display 221. The 2-2th shielding member 226b may be disposed in a lower area of the second digitizer 223b corresponding to the folding area 2211 of the display 221.

For example, the second shielding member 226 may include, as illustrated in FIG. 5B, a 2-1th (second-first) shielding member 226a and a 2-2th (second-second) shielding member 226b disposed to be spaced apart above the hinge structure 234. The 2-1th shielding member 226a may be disposed above the first hinge plate 234b. The 2-1th shielding member 226a may be disposed in a lower area of the first hinge plate 234b corresponding to the folding area 2211 of the display 221. The 2-2th shielding member 226b may be disposed above the second hinge plate 234c. The 2-2th shielding member 226b may be disposed in a lower area of the first hinge plate 234b corresponding to the folding area 2211 of the display 221.

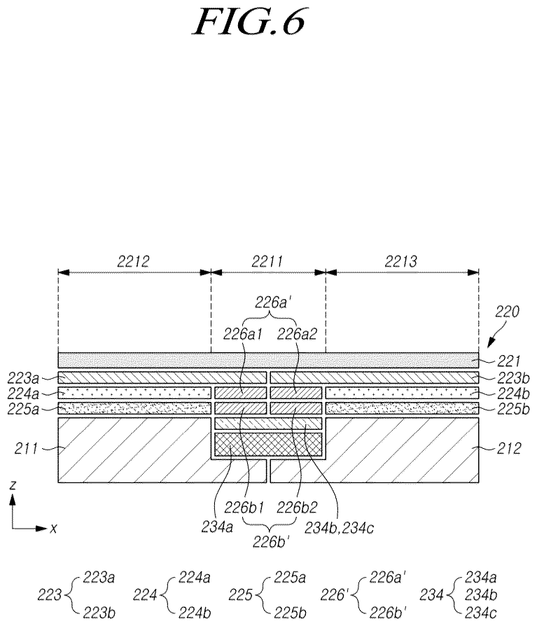

FIG. 6 is a cross-sectional view illustrating an electronic device cut along line I-I′ illustrated in FIG. 2A according to an embodiment of the disclosure.

Referring to FIG. 6, in an embodiment, a display unit 220 of an electronic device 200 may include a display 221, a digitizer 223, a first shielding member 224, and a conductive member 225 sequentially stacked from an upper side to a lower side.

In an embodiment, the display unit 220 may include a second shielding member 226′ disposed in a shielding space (e.g., the shielding space 227 of FIG. 5).

Hereinafter, descriptions of configurations substantially identical to those illustrated in FIG. 5 are omitted.

The second shielding member 226′ may be disposed throughout the shielding space 227.

In an embodiment, the second shielding member 226′ may include a 2-1th shielding member group 226a′ disposed below the digitizer 223 and a 2-2th shielding member group 226b′ disposed above the hinge structure 234.

In an embodiment, the 2-1th shielding member group 226a′ may include a 2-1th shielding member 226al disposed below the first digitizer 223a and a 2-2th shielding member 226a2 disposed below the second digitizer 223b. The 2-1th shielding member 226al may be disposed in a lower area of the first digitizer 223a corresponding to the folding area 2211 of the display 221. The 2-2th shielding member 226a2 may be disposed in a lower area of the second digitizer 223b corresponding to the folding area 2211 of the display 221.

In an embodiment, the 2-2th shielding member group 226b′ may include a 2-3th shielding member 226b1 and a 2-4th shielding member 226b2 disposed above the hinge structure 234. The 2-3th shielding member 226b1 may be disposed above the first hinge plate 234b. The 2-3th shielding member 226b1 may be disposed in an upper area of the first hinge plate 234b corresponding to the folding area 2211 of the display 221. The 2-4th shielding member 226b2 may be disposed above the second hinge plate 234c. The 2-4th shielding member 226b2 may be disposed in an upper area of the first hinge plate 234b corresponding to the folding area 2211 of the display 221.

In this case, the second shielding member 226′ is attached to both a lower portion of the digitizer 223 and an upper portion of the hinge structure 234, so that a total thickness increases compared to the second shielding member 226 disposed in either a lower portion of the digitizer 223 or an upper portion of the hinge structure 234 illustrated in FIGS. 5A and 5B. Accordingly, the second shielding member 226′ may be composed of a magnetic material having lower magnetic permeability to obtain the same shielding performance as the second shielding member 226 illustrated in FIG. 5, and resistance also increases.

In an embodiment, even when the second shielding member 226′ is not a structure attached to two opposite sides of the digitizer 223 and the hinge structure 234, the same shielding performance may be implemented by attaching the second shielding member 226′ to either the digitizer 223 or the hinge structure 234 in the shielding space 227 but making its thickness thicker than the first shielding member 224.

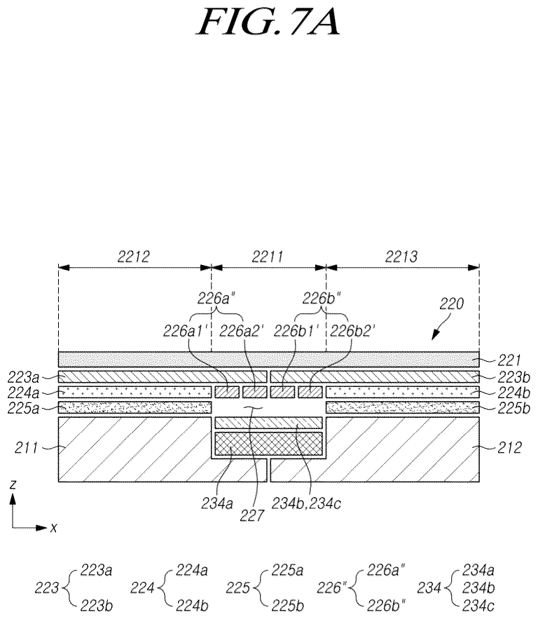

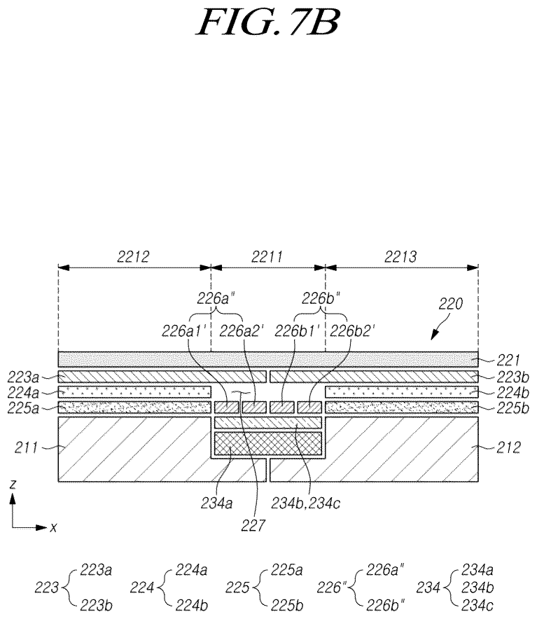

FIG. 7A is a cross-sectional view illustrating an electronic device cut along line I-I′ illustrated in FIG. 2A according to an embodiment of the disclosure. FIG. 7B is a cross-sectional view illustrating an electronic device cut along line I-I′ illustrated in FIG. 2A according to an embodiment of the disclosure.

In an embodiment, a second shielding member 226″ may be composed of a plurality of segments having a smaller size than the second shielding members 226 and 226′ illustrated in FIGS. 5 and 6. For convenience of description, a case where the second shielding member 226″ is composed of four segments is described as an example, but the disclosure is not limited thereto, and the second shielding member 226″ may be composed of n segments.

Referring to FIG. 7, in an embodiment, a display unit 220 of an electronic device 200 may include a display 221, a digitizer 223, a first shielding member 224, and a conductive member 225 sequentially stacked from an upper side to a lower side.

In an embodiment, the display unit 220 may include a second shielding member 226″ disposed in a shielding space 227.

Hereinafter, descriptions of configurations substantially identical to those illustrated in FIGS. 5 and 6 are omitted.

Referring to FIG. 7A, in an embodiment, the second shielding member 226″ may be composed of a plurality of segments spaced apart from each other at predetermined intervals below the digitizer 223. For example, the second shielding member 226″ may include a 2-1th shielding member group 226a″ including a plurality of segments 226al′ and 226a2′ spaced apart from each other below the first digitizer 223a and a 2-2th shielding member group 226b″ including a plurality of segments 226bl′ and 226b2′ spaced apart from each other below the second digitizer 223b.

Referring to FIG. 7B, in an embodiment, the second shielding member 226″ may be composed of a plurality of segments spaced apart from each other at predetermined intervals above the hinge structure 234. For example, the second shielding member 226″ may include a 2-1th shielding member group 226a″ including a plurality of segments 226al′ and 226a2′ spaced apart from each other above the first hinge plate 234b and a 2-2th shielding member group 226b″ including a plurality of segments 226bl′ and 226b2′ spaced apart from each other above the second hinge plate 234c.

In this case, during a folding operation of the electronic device 200, interference between the second shielding member 226″ and other components that may occur in the folding area 2211 of the display 221 is decreased, so that flexibility of the display unit 220 may be further secured.

Further, in an embodiment, by designing magnetic permeability/resistance of a plurality of segments differently, an inductance deviation of the pen input device 300 in the folding area 2211 caused by a separated structure of the digitizer 223 or an inductance deviation of the pen input device 300 when compared before and after magnetization of the hinge structure 234 may be further mitigated.

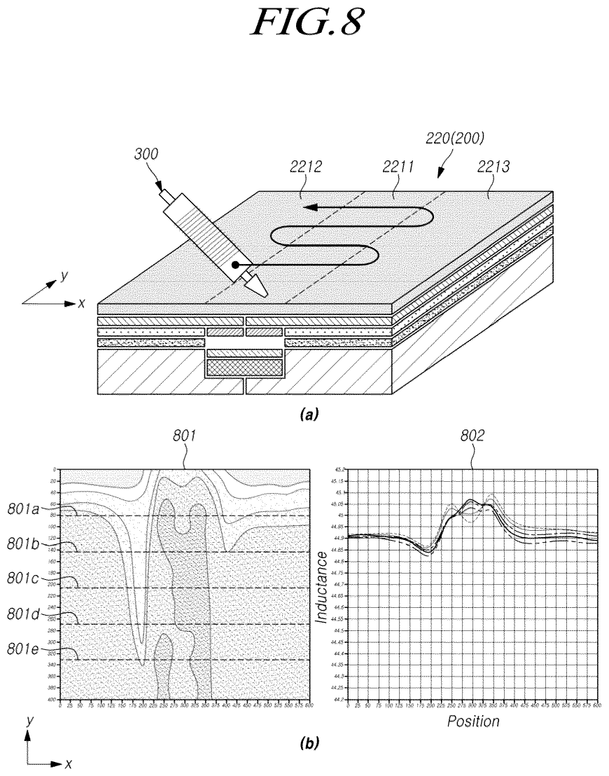

FIG. 8 is a view illustrating a method of scanning an inductance of a pen input device moving on a display of an electronic device according to an embodiment of the disclosure and an inductance of the scanned pen input device.

FIG. 8(a) is a view illustrating a pen input device 300 moving on a folding area 2211 of an exemplary display 221 illustrated in FIG. 5A, and FIG. 8(b) is a 2-dimension (2D) graph 801 and a 1-dimension (1D) graph 802 regarding results of scanning inductance changes of the pen input device 300 moving as illustrated in FIG. 8(a).

Referring to FIGS. 8(a) and 8(b), the pen input device 300 may move within the folding area 2211 of the display 221 of the electronic device 200 by an operator (or user), and an inductance value of the pen input device 300 (e.g., an inductance value corresponding to each X-Y coordinate value in the folding area 2211) may be obtained for each point where the pen input device 300 is positioned.

From a graph 801 illustrating an inductance of the pen input device 300 obtained during an operation illustrated in FIG. 8(a) in a 2D form, a distribution of inductance values of the pen input device 300 on an X-Y coordinate system may be identified. Further, using inductance values corresponding to a plurality of dashed lines 801a, 801b, 801c, 801d, and 801e that are parallel to an X-axis and spaced at predetermined intervals along a Y-axis shown on the graph 801 of FIG. 8(b), a 1D form graph 802 may be obtained.

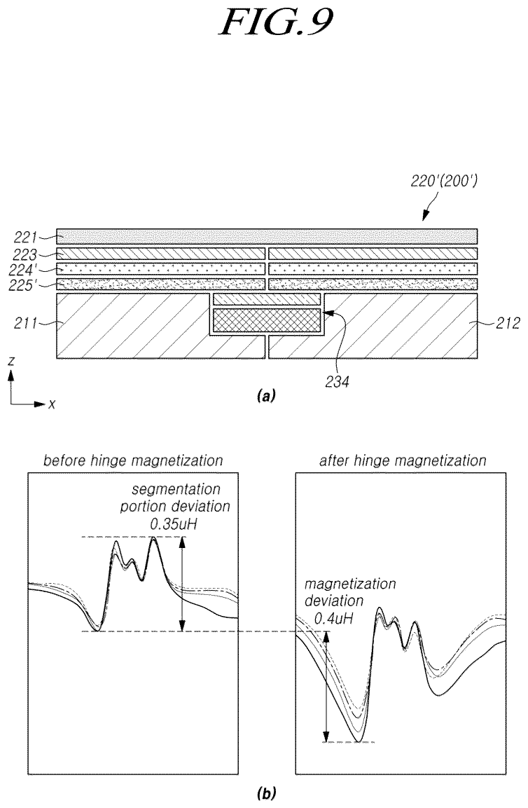

Through 1D form graphs before/after magnetization of the hinge structure 234 generated through the process, shielding performance for each stacked structure of displays is described through FIGS. 9 to 11.

FIGS. 9 to 11 are views for comparing respective shielding performances according to stacked structures of displays of various types of electronic devices according to an embodiment of the disclosure.

FIG. 9(a) is a view illustrating a stacked structure of a display unit 220′ in which a display 221, a digitizer 223, a first shielding member 224′, and a conductive member 225′ are sequentially disposed. FIG. 9(b) is a graph illustrating an inductance of the pen input device 300 in each before/after magnetization of the hinge structure 234 generated by a series of processes illustrated in FIG. 8 in an electronic device 200′ having a stacked structure of the display unit 220′ illustrated in FIG. 9(a).

Referring to FIGS. 9(a) and 9(b), in a graph before magnetization of the hinge structure 234, it may be identified that a difference between a maximum value and a minimum value of an inductance of the pen input device 300 (hereinafter, segmentation portion deviation) corresponds to 0.35 μH. This is because as the conductive member 225′ has a separated structure, an induced current is decreased in an area where the conductive member 225′ is separated (hereinafter, a segmentation portion), so that inductance increases around the segmentation portion. Since the segmentation portion deviation has a similar shape before and after magnetization of the hinge structure 234, calibration is possible. However, as a deviation increases, calibration quality deteriorates, so it is good to reduce a deviation.

In graphs before/after magnetization of the hinge structure 234, it may be identified that a maximum value (hereinafter, magnetization deviation) among inductance difference values at crest to crest or trough to trough of graphs corresponds to 0.4 μH.

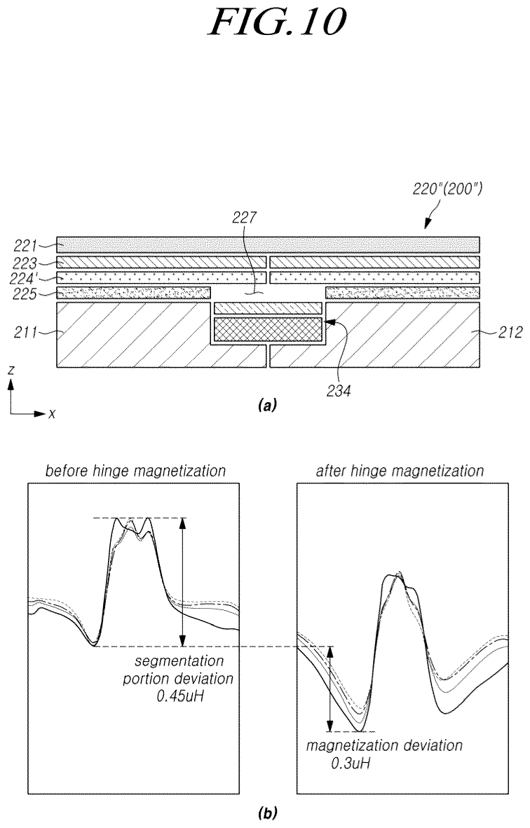

FIG. 10(a) is a view (partially corresponding to a stacked structure illustrated in FIG. 5A) illustrating a stacked structure of a display unit 220″ including a conductive member 225 from which at least a portion corresponding to an upper area of the hinge structure 234 is removed in a stacked structure of the display unit 220′ illustrated in FIG. 9(a). FIG. 10(b) is a graph illustrating an inductance of the pen input device 300 before/after magnetization of the hinge structure 234 generated by a series of processes illustrated in FIG. 8 in an electronic device 200″ having a stacked structure of the display unit 220″ illustrated in FIG. 10(a).

Referring to FIGS. 10(a) and 10(b), as at least a portion of the conductive member 225 corresponding to an upper area of the hinge structure 234 is removed, an induced current of the conductive member 225 around a segmentation portion is decreased, so that inductance increases around the segmentation portion. Accordingly, a segmentation portion deviation increases from 0.35 μH to 0.45 μH compared to a stacked structure of a display unit of FIG. 9.

Further, as at least a portion of the conductive member 225 is deleted, an induced current that would increase due to magnetization of the hinge structure 234 is decreased, so that a magnetization deviation decreases from 0.4 μH to 0.3 μH compared to a stacked structure of a display unit of FIG. 9.

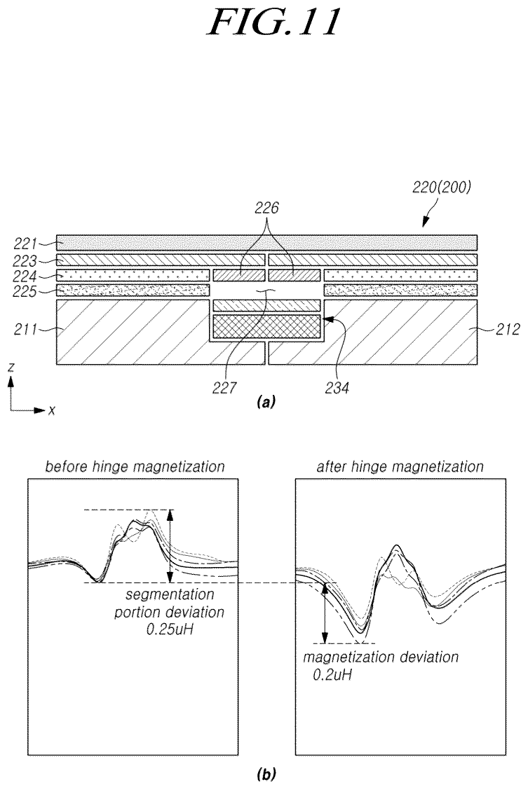

FIG. 11(a) is a view illustrating a stacked structure (corresponding to a stacked structure illustrated in FIG. 5B) of a display unit 220 including a first shielding member 224 from which at least a portion corresponding to a lower area of the digitizer 223 is removed and a second shielding member 226 disposed in the lower area of the digitizer 223 in a stacked structure of the display unit 220″ illustrated in FIG. 10(a). FIG. 11(b) is a graph illustrating an inductance of the pen input device 300 before/after magnetization of the hinge structure 234 generated by a series of processes illustrated in FIG. 8 in an electronic device 200 having a stacked structure of the display unit 220 illustrated in FIG. 11(a).

Referring to FIGS. 11(a) and 11(b), at least a portion of the first shielding member 224 corresponding to a lower area of the digitizer 223 is deleted, and a second shielding member 226 having lower magnetic permeability and higher resistance than the first shielding member 224 is disposed in the deleted lower area of the digitizer 223. In this case, a segmentation deviation decreases from 0.45 μH to 0.25 μH compared to a stacked structure of a display unit of FIG. 10.

Further, as the second shielding member 226 having higher resistance than the existing first shielding member 224 is disposed, magnetic field interference due to magnetization of the hinge structure 234 is decreased. Accordingly, a magnetization deviation decreases from 0.3 μH to 0.2 μH compared to a stacked structure of a display unit of FIG. 10.

Generally, an EMR type pen input device is judged to have an error that a user may not feel even when an inductance of a coil changes by 0.2 μH and, when there is magnetic field interference that causes changes there above, a deviation is corrected through firmware calibration. Pen malfunction due to magnetic components with constant magnetic force such as speakers and motors proceeds with calibration after adjusting to a deviation of 1 μH or less after shielding, but in a case of a hinge, it is a component that may not be corrected by calibration because it has characteristics of changing magnetic force. Consequently, as described above with reference to FIGS. 5 to 7, by varying physical properties (e.g., resistance) and/or arrangement of the shielding members 224 and 226, malfunction of a pen input device may be decreased by satisfying a magnetization deviation within a range of 0.2 μH.

A foldable electronic device 200 according to an embodiment of the disclosure may include a first housing 211. The foldable electronic device 200 may include a second housing 212. The foldable electronic device 200 may include a hinge structure 234 rotatably connecting the first housing 211 and the second housing 212. In an embodiment, the hinge structure 234 is coupled to the first housing 211 and the second housing 212 that are foldable relative to each other.

The foldable electronic device 200 may include a flexible display 221 disposed across the first housing 211 and the second housing 212 and including a folding area 2211. In an embodiment, the flexible display 221 is disposed on the first housing 211 and the second housing 212. In an embodiment, the folding area 2211 is accommodated on the flexible display 221.

The foldable electronic device 200 may include a shielding space 227 facing the folding area 2211 and defined (or being) between the hinge structure 234 and the flexible display 221. The foldable electronic device 200 may include a pair of digitizers 223 disposed to be (or being) spaced apart below the flexible display 221. The foldable electronic device 200 may include a pair of first shielding members 224 disposed below each of the pair of digitizers 223 and spaced apart from each other by the shielding space 227 therebetween. The foldable electronic device 200 may include a plurality of second shielding members 226, 226′, 226″ disposed in the shielding space 227. The plurality of second shielding members 226, 226′, 226″ may have higher resistance than the pair of first shielding members 224. In an embodiment, a first resistance of the plurality of second shielding members 226, 226′, 226″ may be higher than a second resistance of the pair of first shielding members 224.

In an embodiment, the foldable electronic device 200 may further include a pair of conductive members 225 disposed below each of the pair of first shielding members 224 and spaced apart from each other by the shielding space 227 therebetween.

In an embodiment, the flexible display 221 may further include a first area 2212 provided on one side of the folding area 2211 and a second area 2213 provided on the other side of the folding area 2211.

In an embodiment, the pair of digitizers 223 may include a first digitizer 223a disposed on a rear surface of the flexible display 221 facing at least a portion of the folding area 2211 and the first area 2212.

In an embodiment, the pair of digitizers 223 may include a second digitizer 223b disposed on a rear surface of the flexible display 221 facing at least a portion of the folding area 2211 and the second area 2213.

In an embodiment, the plurality of second shielding members 226 may include a 2-1th shielding member 226a attached to a rear surface of the first digitizer 223a.

In an embodiment, the plurality of second shielding members 226 may include a 2-2th shielding member 226b attached to a rear surface of the second digitizer 223b.

In an embodiment, the plurality of second shielding members 226″ may include a 2-1th shielding member group 226a″ composed of a plurality of shielding members 226a1, 226a2 disposed to be spaced apart from each other on a rear surface of the first digitizer 223a.

In an embodiment, the plurality of second shielding members 226″ may include a 2-2th shielding member group 226b″ composed of a plurality of shielding members 226b1, 226b2 disposed to be spaced apart from each other on a rear surface of the second digitizer 223b.

In an embodiment, the plurality of second shielding members 226 may be positioned between the pair of first shielding members 224.

In an embodiment, the hinge structure 234 may include a hinge module 234a, a first hinge plate 234b connected to one side of the hinge module 234a, and a second hinge plate 234c connected to another side of the hinge module 234a.

In an embodiment, the plurality of second shielding members 226 may include a 2-1th shielding member 226a disposed on an upper side of the first hinge plate 234b.

In an embodiment, the plurality of second shielding members 226 may include a 2-2th shielding member 226b disposed on an upper side of the second hinge plate 234c.

In an embodiment, the plurality of second shielding members 226″ may include a 2-1th shielding member group 226a″ composed of a plurality of shielding members 226al′, 226a2′ disposed to be spaced apart from each other on an upper side of the first hinge plate 234b.

In an embodiment, the plurality of second shielding members 226″ may include a 2-2th shielding member group 226b″ composed of a plurality of shielding members 226b1′, 226b2′ disposed to be spaced apart from each other on an upper side of the second hinge plate 234c.

In an embodiment, the plurality of second shielding members 226 may be positioned between the pair of conductive members 225.

In an embodiment, the plurality of second shielding members 226′ may include

a 2-1th shielding member group 226a′ including a plurality of shielding members 226a1, 226a2 separately disposed on respective rear surfaces of the first digitizer 223a and the second digitizer 223b.

In an embodiment, the plurality of second shielding members 226′ may include a 2-2th shielding member group 226b′ including a plurality of shielding members 226b1, 226b2 disposed to be spaced apart from each other on an upper side of the hinge structure 234.

In an embodiment, the 2-1th shielding member group 226a′ may be positioned between the pair of first shielding members 224.

In an embodiment, the 2-2th shielding member group 226b′ may be positioned between the pair of conductive members 225.

In an embodiment, the plurality of second shielding members 226 may be provided with a thickness thicker than the pair of first shielding members 224.

In an embodiment, each of the plurality of second shielding members 226, 226′, 226″ may be provided to have a different permeability.

In an embodiment, the shielding space 227 may be defined by being surrounded by the pair of digitizers 223, the pair of first shielding members 224, the pair of conductive members 225, and the hinge structure 234.

What is claimed is:

1. A foldable electronic device comprising:
a first housing;
a second housing;
a hinge structure rotatably connecting the first housing and the second housing;
a flexible display on the first housing and the second housing;
a folding area accommodated on the flexible display;
a shielding space facing the folding area and being between the hinge structure and the flexible display;
a pair of digitizers being spaced apart below the flexible display;
a pair of first shielding members below each of the pair of digitizers and being spaced apart from each other by the shielding space therebetween; and
a plurality of second shielding members in the shielding space, wherein a first resistance of the plurality of second shielding members is higher than a second resistance of the pair of first shielding members.

2. The foldable electronic device of claim 1, further comprising a pair of conductive members below each of the pair of first shielding members and spaced apart from each other by the shielding space therebetween.

3. The foldable electronic device of claim 2, wherein the flexible display further includes a first area on one side of the folding area and a second area on the other side of the folding area, and wherein the pair of digitizers includes:
a first digitizer on a rear surface of the flexible display facing at least a portion of the folding area and the first area; and
a second digitizer on a rear surface of the flexible display facing at least a portion of the folding area and the second area.

4. The foldable electronic device of claim 3, wherein the plurality of second shielding members includes:
a second-first (2-1th) shielding member attached to a rear surface of the first digitizer; and
a second-second (2-2th) shielding member attached to a rear surface of the second digitizer.

5. The foldable electronic device of claim 3, wherein the plurality of second shielding members includes:
a second-first (2-1th) shielding member group including a plurality of shielding members spaced apart from each other on a rear surface of the first digitizer; and
a second-second (2-2th) shielding member group including a plurality of shielding members spaced apart from each other on a rear surface of the second digitizer.

6. The foldable electronic device of claim 1, wherein the plurality of second shielding members are positioned between the pair of first shielding members.

7. The foldable electronic device of claim 1, wherein the hinge structure includes a hinge module, a first hinge plate connected to a first side of the hinge module, and a second hinge plate connected to a second side of the hinge module.

8. The foldable electronic device of claim 7, wherein the plurality of second shielding members includes:
a second-first (2-1th) shielding member on an upper side of the first hinge plate; and
a second-second (2-2th) shielding member on an upper side of the second hinge plate.

9. The foldable electronic device of claim 7, wherein the plurality of second shielding members includes:
a second-first (2-1th) shielding member group including a plurality of shielding members spaced apart from each other on an upper side of the first hinge plate; and
a second-second (2-2th) shielding member group including a plurality of shielding members spaced apart from each other on an upper side of the second hinge plate.

10. The foldable electronic device of claim 2, wherein the plurality of second shielding members are positioned between the pair of conductive members.

11. The foldable electronic device of claim 3, wherein the plurality of second shielding members includes:
a second-first (2-1th) shielding member group including a plurality of shielding members separately on respective rear surfaces of the first digitizer and the second digitizer; and
a second-second (2-2th) shielding member group including a plurality of shielding members spaced apart from each other on an upper side of the hinge structure.

12. The foldable electronic device of claim 11, wherein the second-first (2-1th) shielding member group is positioned between the pair of first shielding members, and the second-second (2-2th) shielding member group is positioned between the pair of conductive members.

13. The foldable electronic device of claim 1, wherein a thickness of the plurality of second shielding members is higher than a thickness of the pair of first shielding members.

14. The foldable electronic device of claim 1, wherein each of the plurality of second shielding members has a different permeability.

15. The foldable electronic device of claim 3, wherein the shielding space is surrounded by the pair of digitizers, the pair of first shielding members, the pair of conductive members, and the hinge structure.
